(19) United States
(12) Patent Application Publication
(10) Pub. No.: US 2026/0055557 A1
(43) Pub. Date: Feb. 26, 2026

(54) METHOD AND DEVICE FOR PRODUCING A MOLDED FIBER PRODUCT

(71) Applicants: TD GreenRock Beteiligungsholding GmbH, Koeln (DE); Werner Sempell Vermoegensverwaltungs UG (haftungsbeschraenkt), Koeln (DE)

(72) Inventor: Tahsin Dag, Koeln (DE)

(73) Assignees: TD GreenRock Beteiligungsholding GmbH, Koeln (DE); Werner Sempell Vermoegensverwaltungs UG (haftungsbeschraenkt), Koeln (DE)

(21) Appl. No.: 19/103,991

(22) PCT Filed: Aug. 11, 2023
(86) PCT No.: PCT/EP2023/072339

§ 371 Date: Feb. 14, 2025

(30) Foreign Application Priority Data
Aug. 18, 2022 (DE) 10 2022 120 928.8

(51) Int. Cl. D21J 3/00; B27N 5/00; B27N 7/00

(52) U.S. Cl. CPC D21J 3/00; B27N 5/00; B27N 7/005

(57) ABSTRACT

The invention relates to a method for producing a molded fiber product (1), which comprises the following method steps:
arranging in a chamber (5) a suction mold (2) with a porous wall (4) having a contour corresponding to the contour of the molded fiber product (1) to be produced,
introducing a fiber material-air mixture (6) into the chamber (5), the fiber material being distributed in the air in the form of solid particles,
suction of the fiber material-air mixture (6) through the porous wall (4) of the suction mold (2) and compacting the fiber material to form the molded fiber product (1) on the porous wall (4),
removing the molded fiber product (1) from the suction mold (2) and from the chamber (5).

The invention is based on the task of providing a technically simple method and a technically simple device enabling the rapid and energy-efficient production of biodegradable molded fiber products with particularly low waste.

For this purpose, the fiber material consists mainly of cellulose fibers, wherein the fiber material is moist and/or water is added to the fiber material-air mixture in the form of droplets or water vapor.

### TECHNICAL FIELD

This application relates to a method for producing a molded fiber product and a device for producing a molded fiber product.

### BACKGROUND

Molded fiber products are used for various applications, particularly as transport packaging and to protect sensitive goods. For example, molded fiber products are used as an alternative to plastic trays, as molded inserts in packaging and as food packaging.

It is known to produce molded fiber products using the pulp molding process. During this process, a suction mold with a porous wall is immersed in a pulp, also known as a fiber slurry. A pulp usually contains at least water and fibers, which are sucked in by the suction mold. The fibers usually consist of cellulose. Suction is achieved through pores or openings in the porous wall of the suction mold, which are smaller than the fibers. This means that only the water of the pulp is sucked out through the wall of the suction mold, while the fibers are deposited on the wall of the suction mold. The fiber content is increased and compacted on the wall of the suction mold, resulting in a molded fiber product. After demolding the molded fiber product, the dry substance content is further increased by subsequent drying, whereby the molded fiber product is solidified.

The pulp molding process can be used to produce molded fiber products with complex contours on the suction mold. However, drying the wet molded fiber product is very time-consuming and energy-intensive because the molded fiber product deposited on the wall of the suction mold has a very high water content. The water must be evaporated substantially completely so that the formed molded fiber product can be used. Both the consumption of water and the energy consumption for the pulp molding process are quite high.

Alternatives to the pulp molding process are known in the prior art. For example, document SE 541 995 C2 discloses a method for producing a non-flat molded fiber product called cellulose product. The method comprises dry molding cellulose fibers into a flat cellulose web in a dry molding unit. For dry molding the cellulose web, the dry molding unit comprises a separating unit for separating cellulose fibers, a forming screen for forming the web of cellulose fibers and a compacting unit for compacting the cellulose fibers. Water and one or more additives are added to the cellulose fibers and/or the cellulose blank. The cellulose product is formed by heating the cellulose web to a forming temperature in the range from 140° C. to 200° C. and pressing the cellulose blank with a forming pressure of at least 4 MPa. The additive or additives are spread in solid form on the cellulose fibers and/or the cellulose web. During this process, the non-flat molded fiber product is thus produced via the detour of a flat cellulose web.

Document EP 3 889 347 A1 also discloses a method for producing a molded fiber product referred to as a molded product. The method comprises mixing fibers with a composite material to form a mixture, wherein the composite material includes cellulose fibers and 30% to 50% starch at least partially fused with the cellulose fibers. The mixture is moistened at least once, and the moistened mixture is formed into the molded product by pressurization and heating. In particular, the moistened mixture is deposited on a net-like conveyor and enriched there. The conveyor is used to feed the fiber web to a forming device in which the fiber web is pressed. During this process, too, the molded fiber product is thus produced via the detour of a flat fiber web.

The production of a fiber web, which is then brought into the shape of the molded fiber product to be produced, is time-consuming and energy-intensive. Furthermore, the fiber web can thin out and/or tear while being pressed into the intended shape because pressing involves extensive deformation of the fiber web.

Documents U.S. Pat. No. 5,376,327 A and DE 10 2015 200 275 A1 describe processes for manufacturing molded fiber products with carbon fibers and plastic fibers.

### SUMMARY OF INVENTION

It is desirable to provide a technically simple method and a technically simple device enabling rapid and energy-efficient production of biodegradable molded fiber products with particularly low waste.

The method described herein for producing a molded fiber product includes the following method steps:
arranging in a chamber a suction mold with a porous wall having a contour corresponding to the contour of the molded fiber product to be produced,
introducing a mixture of fiber material and air into the chamber, wherein the fiber material is distributed in the air in the form of solid particles,
suction of the fiber material-air mixture through the porous wall of the suction mold and compacting the fiber material to form the molded fiber product on the porous wall,
removing the molded fiber product from the suction mold and from the chamber,
wherein the fiber material consists mainly of cellulose fibers and wherein the fiber material is moist and/or water is added to the fiber material-air mixture in the form of droplets or water vapor.

The system described herein is thus based on the idea of depositing the starting materials from which the molded fiber product is formed (i.e. in particular fiber material) directly from the air onto a porous wall of a suction mold and compacting the molded fiber product there, so that immediately after the starting materials have been deposited and compacted the molded fiber product has the geometry (contour) to be produced or at least substantially the geometry (contour) to be produced.

The molded fiber product is formed from biodegradable and preferably compostable starting materials. The fiber material is then formed—depending on the requirements for the optical characteristics of the molded fiber product—mainly from cellulose, other recyclable fibers and/or from virgin fibers, each of which is biodegradable and preferably compostable. As a result, the molded fiber product itself is also biodegradable and preferably compostable. The fibers may consist mainly of cellulose fibers, as is known from the conventional production of molded fiber products using the pulp molding process. However, other fibers, e.g. hemp fibers, may also be used. This enables producing molded fiber products with high strength and good mechanical properties. Depending on the intended use, the fibers may also be mixed from different starting materials.

The fiber material may be introduced into the fiber material-air mixture in a slightly moistened state so that the fiber material sets during compaction to form the molded product. The moisture in the fiber material may cause problems when the fibers swirl in the air. For this reason, water in the form of droplets or water vapor may be added to the fiber material-air mixture in a swirled state in order to achieve the optimum moisture for setting the fibers during compaction. It is also possible to swirl completely dry fibers with air and to add to the swirled fiber/air mixture the full amount of water required for setting.

In some embodiments, a first mixture of fiber material and air may be introduced into the chamber and drawn in, so that a first layer of fiber material is formed on the porous wall of the suction mold, and then at least one further mixture of fiber material and air may be introduced into the chamber and drawn in, so that at least one further layer of fiber material is formed on the porous wall of the suction mold. The layers of fiber material may be compacted to form the molded fiber product on the porous wall and the molded fiber product may be removed from the suction mold. In other words, a first mixture may be fed to the chamber to form a first layer on the porous wall and then a second layer may be fed to form a second layer on the first layer. This process may be repeated with a third and fourth layer etc. if necessary. The mixture of fiber material and air used to form the different layers may be different. For example, the first fiber material-air mixture may have a different dye than the second fiber material-air mixture. In this case, the outer layer of the resulting molded product has a different color than the inner layer. Different additives may also be added to the layers. If, for example, the molded fiber product is to be used for packaging food, the inner layer may be composed in such a way that direct contact of the molded fiber product with the food is harmless. A second layer may be deposited on the inner layer, the second layer providing the molded fiber product with a certain impermeability or strength, but which is not suitable for direct contact with food. It is also possible to form multi-layered molded products in which each layer has a separate function, for example a high level of impermeability to the passage of oxygen, a high level of moisture resistance, a high level of light resistance. These different properties in the different layers may be achieved by changing the composition of the fiber-air mixture in each case in order to produce a layer with a specific desired property.

The suction mold may be a hollow body, for example, which has a porous wall and a suction opening, fluidly connected to the pores of the wall, for connecting a suction device. Alternatively, the suction mold may be designed as a body formed from a porous structure with a suction opening for connecting a suction device. In this case, a surface or at least a surface section of the body forms the porous wall of the suction mold. The contour of the porous wall corresponds to the contour of the molded fiber product to be produced. In other words, the surface geometry of the porous wall or a section of the porous wall and a surface geometry of the molded fiber product to be produced are complementary or substantially complementary to one another. Using the suction device that may be connected to the suction mold, either a negative pressure or an overpressure may be generated in the suction mold and air may be sucked in or blown out through the pores of the porous wall of the suction mold. The pores in the porous wall are preferably designed in such a way that the fiber material is deposited on the wall when the fiber material-air mixture is sucked in.

The porous wall of the suction mold may be formed by a metallic wire screen, for example. However, the wall of the suction mold may also be produced as a solid wall with air channels using an additive manufacturing process (3D printing), for example. In the second case, the suction mold has greater stability.

The chamber is a predefined space in which the molded fiber product is formed on the porous wall of the suction mold. The space may have a surrounding wall with one or more openings, where the starting materials forming the molded fiber product and/or the suction mold may be introduced into the space through the opening. The opening in the surrounding wall may, for example, be at least partially closable using a door, a flap or a slide. The surrounding wall and the at least partially closable opening effectively prevent the fiber material-air mixture from leaking into the air outside the chamber.

The suction mold may be arranged in the chamber manually or automatically. Automatic arrangement allows for automation of the method described herein. Automatic arrangement may, for example, be performed by a suction mold carrier that is moved by an actuator that may be driven electrically or pneumatically, for example. The actuator drive may be functionally connected to a control unit. The suction mold carrier may, for example, be designed as a conveyor on which the suction mold is arranged and with which the suction mold is moved from a support position into the chamber. Alternatively, the suction mold carrier may be a robot arm, for example.

In the method described herein, a plurality of suction molds with identically or differently shaped porous walls may also be arranged in the chamber simultaneously, so that a plurality of molded fiber products with identically or differently shaped contours may be formed simultaneously. In the case of small molded fiber products, each molded fiber product may also correspond to one of several sections of the porous wall of the suction mold. By producing several molded fiber products simultaneously, the production of several molded fiber products may be particularly fast and energy-efficient.

Before, during or after the suction mold is arranged in the chamber, the fiber material-air mixture is introduced into the chamber. For this purpose, the fiber material-air mixture may be premixed outside the chamber so that the fiber material is already distributed in the air in the form of solid particles when the fiber material is introduced. In this case, the fiber material-air mixture may be blown into the chamber, for example. Alternatively, the fiber material may be introduced into the chamber separately from the air. For example, the fiber material may be continuously strewn into the chamber, which is already filled with air, during the molding process or poured into the chamber, which is already filled with air, in one iteration.

With the method described herein, the desired molded fiber product is thus formed directly in a single molding step, without first producing an intermediate product for further processing. This saves considerable time. In addition, the molded fiber product formed contains hardly any water and therefore does not need to be dried. Water is only added—if at all—to the extent that water is required for optimum setting of the components of the wall of the molded fiber product.

Regardless of the manner of introducing the fiber material, it may be advantageous to actively and specifically move the air, the fiber material and/or the fiber material-air mixture in the chamber in order to achieve homogeneous mixing of the air with the starting materials from which the molded fiber product is formed. The active and specific movement of the air, the fiber material and/or the fiber material-air mixture takes place using a device for mixing the fiber material with air, for example a propeller. The propeller swirls the air and/or the fiber material-air mixture so that the fiber material is homogeneously distributed in the air. In particular, the propeller may generate an upward flow. This may create a fluidized bed in the chamber. A fluidized bed is a fill of solid particles that is whirled up by an upward flow of a fluid and put into a fluidized state. The term “fluidized” means that the (former) fill has fluid-like properties. As an alternative or in addition to the propeller, the device for mixing the fiber material with air may, for example, have an oscillating membrane, wherein the oscillating membrane whirls up the air in front of the oscillating membrane, the fiber material-air mixture and/or particles of the starting materials deposited on the oscillating membrane by oscillation.

To form the molded fiber product, air is sucked in through the porous wall of the suction mold. Thereby, the fiber material is deposited on the porous wall. After a certain suction time, the fiber material has compacted on the porous wall due to the suction of the fiber material-air mixture and a molded fiber product with a desired contour and wall thickness has been formed.

When a predetermined suction time and/or a desired wall thickness of the molded fiber product has been reached, the molded fiber product is removed from the suction mold and from the chamber and processed further or deposited in an intermediate storage area.

In practice, the porous wall of the suction mold may have a three-dimensional contour with several wall sections. The wall sections of the suction mold define different sections of the molded product to be produced. The individual wall sections may extend in a flat manner or be designed convex and/or concave. As a result, three-dimensional molded fiber products with several surface sections may be formed on the porous wall, for example a cup-shaped molded fiber product with a flat bottom and a cylindrical cup wall. As mentioned above, several molded fiber products may also be formed on several surface sections of a suction mold.

Furthermore, in practice the fiber material may be mixed with the air in the form of fiber dust or short fibers to form the fiber material-air mixture and/or the fiber material-air mixture may be an aerosol, where the fiber material is distributed as suspended particles in the air. Fiber dust is defined as fiber material whose fibers are smaller than 500 μm and preferably smaller than 200 μm. If the fibers of the fiber material are even smaller than 20 μm and further preferably smaller than 10 μm, the fiber material-air mixture may be an aerosol. An aerosol is a mixture of solid and/or liquid suspended particles in a gas. The fiber material then floats in the air and sinks only very slowly and in particular does not precipitate within a few seconds. In the case of an aerosol, the fiber material is regularly distributed homogeneously in the air, so that the fiber material may be deposited particularly evenly distributed on the porous wall of the suction mold in the method described herein. To distribute the fiber material in the air, an aerosol requires at most an occasional active and specific movement of the fiber material-air mixture. This makes the formation of the molded fiber product technically simple and particularly energy-efficient. Furthermore, it is possible to achieve excellent properties of the molded fiber product to be produced with the very small particles of the fiber material of an aerosol. For example, the molded fiber product may have a particularly high strength, high impermeability and/or high resistance to moisture or to aggressive substances. However, it is also possible to process significantly longer fibers. This may then require stronger swirling so that the fibers are deposited evenly on the porous surface of the suction mold. A longer fiber length may be particularly desirable when processing hemp fibers.

In practice, at least one of the following additives may additionally be added to the fiber material-air mixture:
sugar and/or starch,
wax,
lipids,
minerals.

The additives may also be starting materials from which the molded fiber product is formed. If at least one of the additives is provided, the air and the starting materials, i.e. the fiber material and the at least one additive, are drawn in by the suction mold and the starting materials are deposited together on the porous wall of the suction mold. This results in a molded fiber product with evenly distributed starting materials. The properties of the molded fiber product may be further improved by the additives, in particular strength, impermeability and/or resistance to moisture may be further increased.

The water may be added in the form of droplets or as water vapor if the fluidized fiber material itself is not sufficiently moist. The water may be deposited on the surface of the fiber material and/or penetrate the fiber material. The adhesion of the water may increase the mutual adhesion of the fibers deposited on the porous wall. In addition, the water may solvate the fiber material and thus further increase the adhesion of the fibers. Overall, this way a stable fiber bond may be achieved, which allows the molded fiber product to be easily and safely removed from the suction mold. The strength of the finished molded fiber product may also be increased as a result. However, the water content of this molded fiber product is considerably lower than when produced from a fiber pulp.

The starting materials may also contain sugar, in particular glucose, sucrose, fructose, maltose, lactose, raffinose, stachyose, as well as starch or a mixture of at least two of the aforementioned components. Furthermore, the sugar or starch may be added in particular in the form of solid particles. The sugar or starch may also be used to increase the mutual adhesion of the fibers deposited on the porous wall, especially if the sugar or starch is first heated, fused and/or dissolved by moisture, and later cooled or dried again in the molded fiber product. The sugar or starch then serves as a natural adhesive that bonds the fibers of the molded fiber product. The sugar or starch may also increase the hardness and abrasion resistance of the molded fiber product because the hardness of sugar crystals is regularly greater than the hardness of most fiber materials and, in particular, greater than the hardness of cellulose fibers.

The wax may be added in the form of solid particles or drops. In particular, carnauba wax and/or beeswax may be added. Carnauba wax is a very hard, tropical wax with a high melting temperature (approx. 85-89° C.). Carnauba wax has hardly any odor or taste of its own and is waterproof. Carnauba wax is very brittle when dry and hardens within seconds. Due to its hardness, carnauba wax is also very resistant to abrasion. Carnauba wax is approved for food packaging and has long been used as a coating to increase the shelf life of mangoes, sweets, etc. In addition, the wax may contain beeswax or other natural waxes. Combinations of biodegradable and preferably also compostable waxes may be used, which give the molded fiber product high strength and are particularly suitable for use with packaged foods. Apart from carnauba wax and beeswax, shellac and sugar cane wax, for example, are also suitable. Beeswax is a wax produced in Europe, among other places, which is less hard than carnauba wax. In a mixture with carnauba wax, beeswax helps to reduce brittleness. Beeswax also has hardly any odor or taste of its own and is approved for use in connection with food. The melting point of beeswax is approx. 65° C.

The lipids may also be added in the form of solid particles or droplets. Lipids are hydrophobic. If the lipids are contained in the molded fiber product, the lipids may therefore reduce the wettability of the molded fiber product and/or increase the impermeability of the molded fiber product to moisture.

It should be noted that the list of additives is not exhaustive. Further additives such as minerals or proteins, but also colorants, may be added to the fluidized fiber-air mixture. The additives to be added are selected depending on the product to be manufactured and, in particular, the desired product properties.

The size of the additives added as solid particles or droplets is selected in such a way that the additives are homogeneously distributed in the chamber together with the fiber material and thus the fiber material-air mixture contains the additives evenly distributed. Since the additives are deposited and compacted together with the fiber material as intended, the additives added as solid particles or droplets are preferably larger than the pores in the porous wall of the suction mold. If the fiber material is mixed with the air as fiber dust, the particle size of the additives may preferably correspond to the particle size of the fiber material. If the fiber material-air mixture is an aerosol, the particle size of the additives may be selected to be so small that the additives float with the fibers in the chamber and thus the fiber material-air mixture containing the additives is an aerosol taken as a whole. The particle size of the additives may then be less than 20 um in particular and preferably less than 10 μm. The water may in particular be vaporous.

In practice, the additives may be stored in separate storage containers. In this case, the additives may be mixed with the fiber material before the starting materials are introduced into the chamber. Alternatively, the fiber material and the additives stored in separate storage containers may be introduced into the chamber separately, which allows a particularly high degree of flexibility. For example, the fiber material may be introduced as described above, and the additives may be mixed with air in the separate storage containers to form separate additive-air mixtures, fluidized and then fed to the chamber as separate flows through pipes. By swirling the flows in the chamber, the additives are homogeneously mixed with the fibers and the air in the chamber to form the fiber material-air mixture.

The molded fiber product may be removed from the suction mold using a transfer mold. For this purpose, the transfer mold may have a wall that is substantially complementary to the porous wall of the suction mold and may be pressed with a certain amount of pressure against the molded fiber product formed on the porous wall of the suction mold. This allows the molded fiber product to be compacted. In particular, if the porous wall of the suction mold is formed using additive manufacturing with a large wall thickness, a high strength of the formed molded fiber product may already be achieved by pressing the suction mold and transfer mold together.

In practice, the molded fiber product may be transferred to a press mold after removal from the suction mold and a counter mold may be pressed against the molded fiber product arranged in the press mold. The press mold has a wall whose contour substantially corresponds to the contour of the porous wall of the suction mold. Preferably, the wall of the press mold has no pores or smaller and/or fewer pores than the porous wall of the suction mold. The wall of the press mold is preferably smooth. The counter mold has a wall that is substantially complementary to the wall of the press mold and is also preferably smooth. The counter mold may also have pores.

By pressing the counter mold against the molded fiber product arranged in the press mold, the molded fiber product may be clamped over an entire surface of the molded fiber product between the wall of the press mold and the wall of the counter mold, and the molded fiber product is pressed and further compacted by the mechanical pressure. Due to the substantially complementary walls of the press mold and the counter mold, the contour of the molded fiber product may be easily changed. In particular, small shoulders and/or undercuts may be introduced. Furthermore, pressing the counter mold against the molded fiber product may produce a uniform wall thickness of the molded fiber product. The surfaces of the molded fiber product may be made particularly smooth by pressing and the molded fiber product may therefore have a high-quality appearance. If the molded fiber product contains residual water, the water may be pressed out of the molded fiber product. Unlike a molded fiber product made from a pulp, however, a molded fiber product made according to the system described herein has only a very low water content and only needs to be dried slightly—if at all.

Once the pressing of the press mold and the counter mold against one another has been completed, the press mold and the counter mold may be separated from each other. The counter mold is then no longer in engagement with the press mold. The molded fiber product may be removed and processed further.

In practice, it is also possible to press the molded fiber product in several steps. For this purpose, after pressing in the suction mold and the transfer mold, the molded fiber product may be pressed in a first press mold with a first counter mold. If necessary, the molded fiber product may be transferred to a second press mold and pressed with a second counter mold. Further pressings may be carried out in analogy thereto. The density may be successively increased and/or the surface quality of the molded fiber product may be successively improved by repeated pressing in different press molds.

In practice, as already mentioned, the removal and/or transfer of the molded fiber product from the suction mold to the press mold may be carried out using a transfer mold. The transfer mold has a wall that is substantially complementary to the porous wall of the suction mold. The transfer mold may be arranged on a transfer mold carrier that may be driven by an actuator and is functionally connected to a control unit. The transfer mold may be brought into engagement with the suction mold in such a way that the wall of the transfer mold rests against the molded fiber product and removes the molded fiber product from the suction mold. The transfer mold then transfers the molded fiber product into an intermediate storage area or into the press mold. The transfer mold may also be used to transfer the molded fiber product from a first press mold to another press mold. In practice, the transfer mold may be the counter mold described above, which is used to press the molded fiber product against the porous wall of the suction mold and/or the press mold.

The wall of the transfer mold may have pores, where the pores are fluidly connected to a suction device in order to generate a negative pressure or positive pressure at the pores. The negative pressure sucks the molded fiber product during removal from the suction mold, transfer to the press mold and removal from the press mold. The positive pressure makes it easy to detach the molded fiber product from the transfer mold. At the same time, air may be blown through the porous wall of the suction mold to support the release of the molded fiber product.

In practice, the suction mold, the press mold and/or the counter mold may be heated. Heating the suction mold may serve to heat the starting materials to a predetermined temperature at which the starting materials may be processed particularly well and the fibers adhere particularly well to one another. In particular, the suction mold, the press mold and/or the counter mold may be heated to a temperature of 130° C. to 300° C. and preferably from 180° C. to 240° C. These temperature ranges include temperatures above the melting temperature of most waxes (in particular carnauba wax and beeswax) and many sugars (in particular glucose, sucrose, fructose, maltose, lactose, raffinose, stachyose or starch), so that the wax and/or the sugar/starch in the molded fiber product may be liquid on the suction mold, the press mold and/or the counter mold. Furthermore, if the molded fiber product contains water, the water evaporates from the molded fiber product at the temperatures of the above-mentioned temperature windows and the molded fiber product is dried.

In practice, the molded fiber product may additionally be coated with a coating solution. The coating solution may contain at least one of the following components:
cellulose fibers;
casein;
whey;
agar agar;
psyllium husks.

If the molded fiber product contains moisture, the coating may take place in particular after the moisture has been removed from the molded fiber product. The coating of the molded fiber product may be carried out in particular by spraying a coating solution onto the molded fiber product in the suction mold, the press mold, the counter mold and/or in a coating station. Additionally or alternatively, the molded fiber product may also be immersed in a coating solution in a coating station for coating or may be doused with a coating solution. The coating may also be applied as a partial coating to only part of the surfaces of the molded fiber product.

A coating may give the molded fiber product advantageous properties. For example, a color layer or a water-repellent functional layer may be applied. The coating may also increase the impermeability of the molded fiber product and resistance of the molded fiber product to moisture or aggressive substances. Finally, the coating may increase the strength. In this way, hard objects such as knives or forks may be formed from molded fiber products.

The system described herein also relates to a device for producing a molded fiber product. The device has at least the following components:
a chamber,
at least one device for mixing fiber material with air to produce a fiber material-air mixture in the chamber,
at least one suction mold configured to be arranged in the chamber and having a porous wall for depositing and compacting fiber material from the fiber material-air mixture, the contour of the porous wall corresponding to the contour of the molded fiber product to be produced, and
at least one suction device.

The at least one suction device is fluidly connected to the suction mold so that a negative pressure or positive pressure may be generated on the porous wall. The device may also have more than one suction mold. In this case, each of the suction molds is fluidly connected to the suction device or to a separate suction device. In particular, the porous wall of the suction mold may have a three-dimensional contour with several wall sections, where the wall sections may be designed flat, convex and/or concave. The suction mold may also have several wall areas, each of which forms a molded fiber product. The method described above may be carried out with the device. The description of the device therefore also includes the features described above in connection with the method and their advantages.

In practice, the device for mixing the fiber material with air to form the fiber material-air mixture may have a propeller and/or an oscillating membrane. The movement of the propeller or the oscillating membrane allows the starting materials to be mixed effectively and homogeneously with the air in the chamber to form the fiber material-air mixture, as described above.

In practice, the device may further include at least one of the following elements, the above description further explaining details of the elements and effects associated with the elements:
at least one suction mold carrier that may be driven by an actuator;
separate storage containers for the fiber material, water, sugar, starch, wax and/or lipids;
at least one device for heating the fiber material, the water, the sugar, the starch and/or the wax;
at least one device for mixing water, sugar, starch and/or wax with air;
at least one transfer mold;
at least one transfer mold carrier that may be driven via an actuator;
at least one press mold and at least one counter mold for pressing the molded fiber product;
at least one device for heating the suction mold, the press mold and/or the counter mold;
at least one coating station for coating the molded fiber product;
at least one control unit.

All elements of the device may be functionally connected to the at least one control unit, so that the device may carry out the method automatically.

### BRIEF DESCRIPTION OF DRAWINGS

Further practical embodiments and advantages of the invention are described below in connection with the drawings. The drawings show in:

FIG. 1 a schematic representation of a device according to the system described herein for producing a plurality of molded fiber products;

FIG. 2 a first partial representation of the device of FIG. 1 and the introduction of starting materials into the chamber;

FIG. 3 the partial representation of FIG. 2 and the suction of the starting materials onto the suction molds;

FIG. 4 the partial representation of FIG. 2 with the molded fiber products formed;

FIG. 5 the partial representation of FIG. 2 with a transfer device above the molded fiber products;

FIG. 6 the partial representation of FIG. 2 and the removal of the molded fiber products from the suction mold;

FIG. 7 the partial representation of FIG. 2 and the transfer of the molded fiber products in the transfer mold at a first point in time;

FIG. 8 a second partial representation of the device of FIG. 1 and the transfer of the molded fiber products in the transfer mold at a second point in time;

FIG. 9 a third partial representation of the device and the pressing of the molded fiber products in press molds;

FIG. 10 the partial representation of FIG. 9 and the transfer of the pressed molded fiber products to a conveyor;

FIG. 11 the partial representation of FIG. 9 and the molded fiber products deposited on the conveyor.

### DESCRIPTION OF VARIOUS EMBODIMENTS

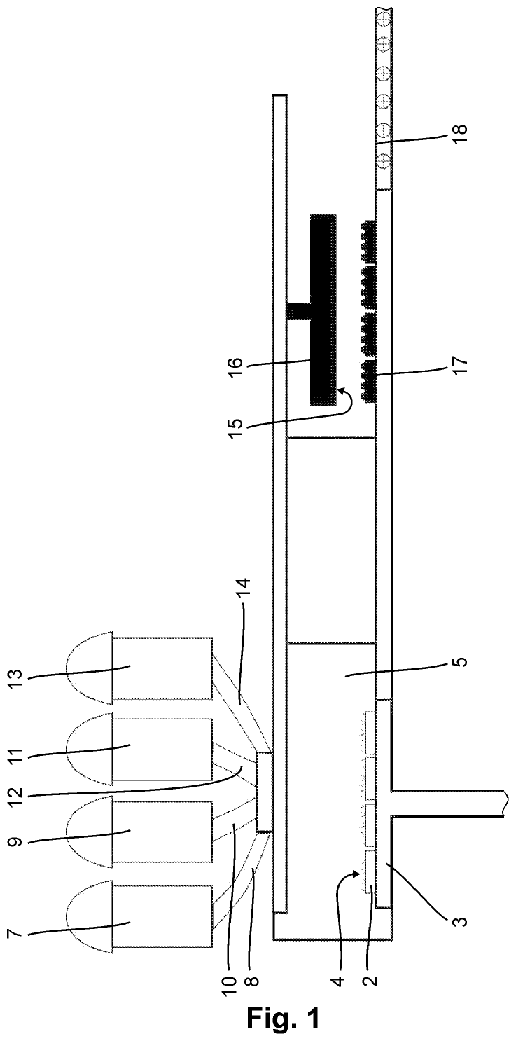

FIGS. 1 to 11 show the progress of the method described herein and a device for carrying out the method. With the device shown in the figures, four molded fiber products may be produced simultaneously. It should be noted that a method according to the invention and the device are not limited to the simultaneous production of four molded fiber products. Rather, the number of simultaneously produced molded fiber products may be adapted to the requirements. In the following, the production is described using the example of a single one of the four molded fiber products shown, wherein a suction mold is provided for each molded fiber product. It should be noted that a suction mold with several surface areas may also be used, with one molded fiber product being produced in each surface area. In the figures, identical components are designated with identical reference numbers.

To produce a molded fiber product 1, first a suction mold 2 is provided. The suction mold 2 is designed as a hollow body with a plurality of walls surrounding a cavity, one of the walls being porous. The suction mold 2 is arranged on a suction mold carrier 3 carrying a plurality of suction molds in such a way that the porous wall 4 of the suction mold 2 points upwards. The contour of the porous wall 4 corresponds to the contour of the molded fiber product 1 to be produced. It is designed three-dimensional and includes several wall sections, one part of which is flat and another part of which is convex. In the example described herein, the molded fiber product 1 and the porous wall 4 have the overall contour of an egg tray or egg carton. The porous wall 4 of the suction mold 2 may either consist of a wire mesh or be formed using an additive manufacturing process.

On the side opposite the porous wall 4, the suction mold 2 has a suction opening (not shown), with which the pores of the porous wall 4 are fluidly connected to a suction device (not shown). The fluid connection is realized in the present case by the fact that the suction mold carrier 3 is hollow and air may flow into the suction mold carrier 3 through openings (not shown) placed below the suction mold 2 in the suction mold carrier 3 and to the suction device. The suction device is a pump, for example.

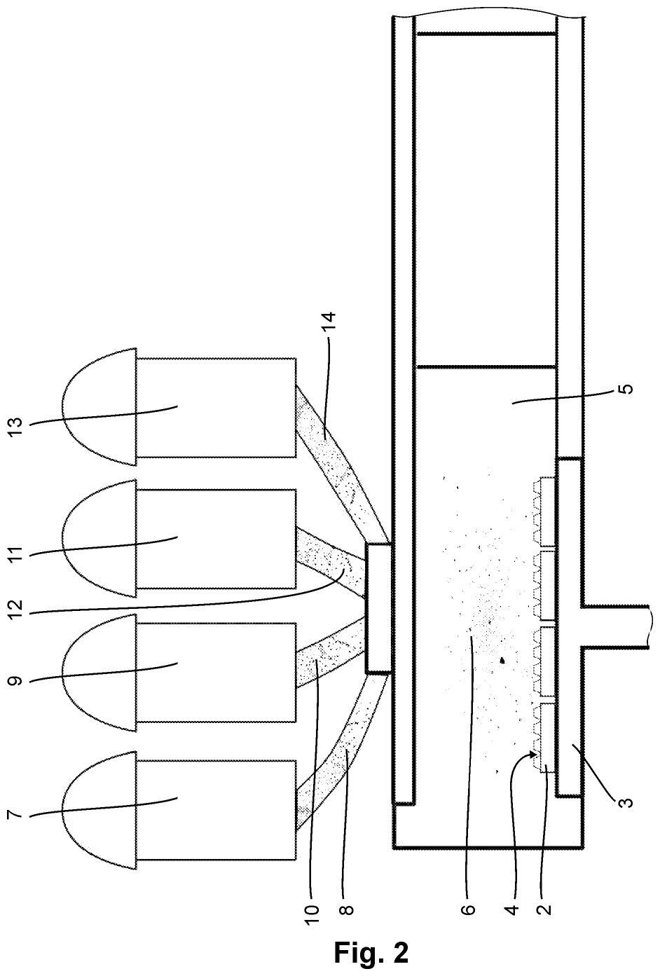

Using the suction mold carrier 3, the suction mold 2 is introduced into a chamber 5 filled with air to form the molded fiber product 1. The suction mold 2 introduced into the chamber 5 is shown, for example, in FIG. 2. For the purpose of introduction, the chamber 5 has a first opening at the bottom, through which the suction mold 2 is introduced and which is completely closed by the suction mold carrier 3 when the suction mold 2 has been introduced into the chamber. Alternatively, the suction mold carrier 3 may be arranged substantially completely in the chamber 5 and the opening may be closed by means of a separate device.

As also shown in FIG. 2, after the suction mold 2 is introduced into the air-filled chamber 5, a fiber material-air mixture 6 is introduced into the chamber 5. The fiber material-air mixture 6 has at least the components air and fiber material. If the fiber material does not have sufficient moisture, water may additionally be added in the form of fine droplets or vapor. The fiber material-air mixture 6 may further include the additives sugar, starch and wax, where the sugar is preferably lactose and the wax may be a mixture of carnauba wax and beeswax. The fiber material, the water, the sugar/starch and the wax are the starting materials from which the molded fiber product 1 is formed. The fiber material is stored in a first storage container 7. The fiber material is deposited into the chamber 5 in the form of solid particles through a first pipe 8 and a second opening in the top wall of the chamber 5. When the fiber material is deposited, the fiber material mixes with the air already contained in the chamber 5 to form the fiber material-air mixture 6. The particle size of the fibers may be 10 μm or smaller, so that the fiber material floats in the air in the chamber 5 in the form of suspended particles and the fiber material-air mixture 6 is an aerosol. Alternatively, it is also possible that significantly longer fibers are used, for example with a length of approx. 200 μm, which sink onto the suction mold after the longer fibers have been deposited.

The water is stored in a second storage container 9. The water is heated using a first heating device, not shown here, until the water evaporates and then flows in the form of vapor through a second pipe 10 and through the second opening into the chamber 5. As an alternative to introducing the water into the chamber 5 in the form of vapor, the water may also be sprayed into the chamber 5 in the form of droplets. For this purpose, a pump (not shown here) may pump the water from the second storage container 9 through the second pipe 10 to the second opening and the water may be sprayed into the chamber 5 there, for example, using a nozzle. The second pipe 10 forms the feeding device for the water. In this case, the first heating device is not required, but may optionally be used to enable spraying heated water droplets into chamber 5. The sugar is stored in a third storage container 11 and deposited into chamber 5 in the form of solid particles through a third pipe 12 and the second opening. The wax is stored in a fourth storage container 13 and deposited into chamber 5 in the form of solid particles through a fourth pipe 14 and the second opening. The introduction of the different starting materials into the chamber 5 may take place simultaneously or successively. If the fiber material is introduced in the form of suspended particles, the sugar and wax particles may also be so small that the particles float at least briefly in the fiber material-air mixture 6. As a result, the air, the fiber material, the water vapor, the sugar particles and the wax particles mix in the chamber 5 to form the fiber material-air mixture 6 without actively and specifically supporting this. During mixing, the vapor moistens the fiber material and the sugar. This causes the starch in the fibers and the sugar to solvate.

In addition, it is possible to whirl up the air or the fiber material-air mixture 6 in the chamber 5 using a device, not shown here, for mixing the fiber material with air in the form of a propeller or an oscillating membrane. This allows the starting materials to be distributed even more effectively and evenly in the air. With the device for mixing the fiber material, a flow of the fiber material-air mixture 6 directed from the bottom of the chamber 5 in the direction of the top wall of the chamber 5 and thus a fluidized bed may be generated in the chamber 5. This also makes it possible to process significantly larger particles, which sink in the air without the fluidizing means.

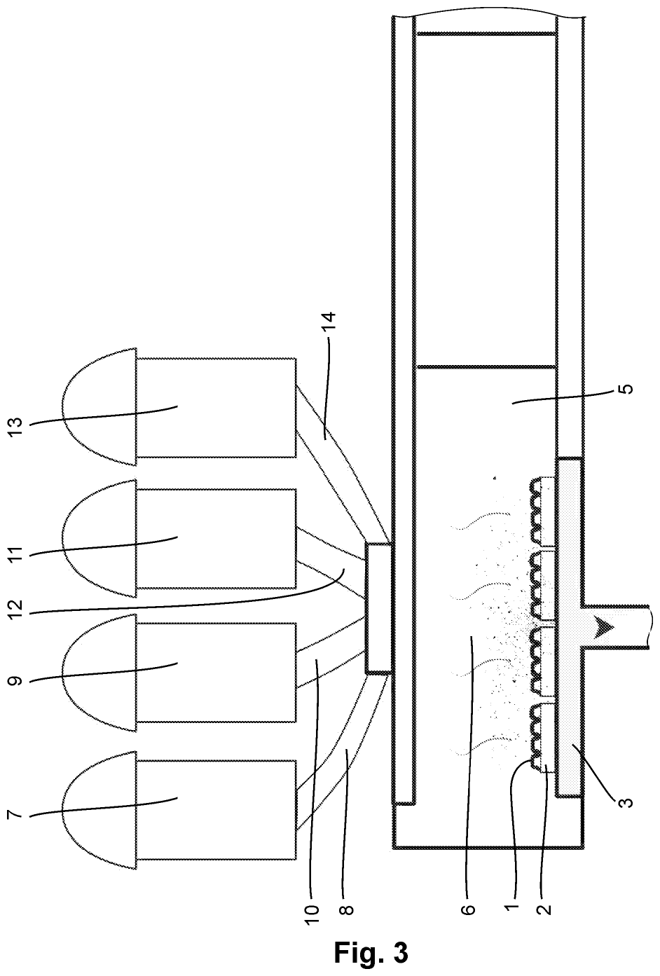

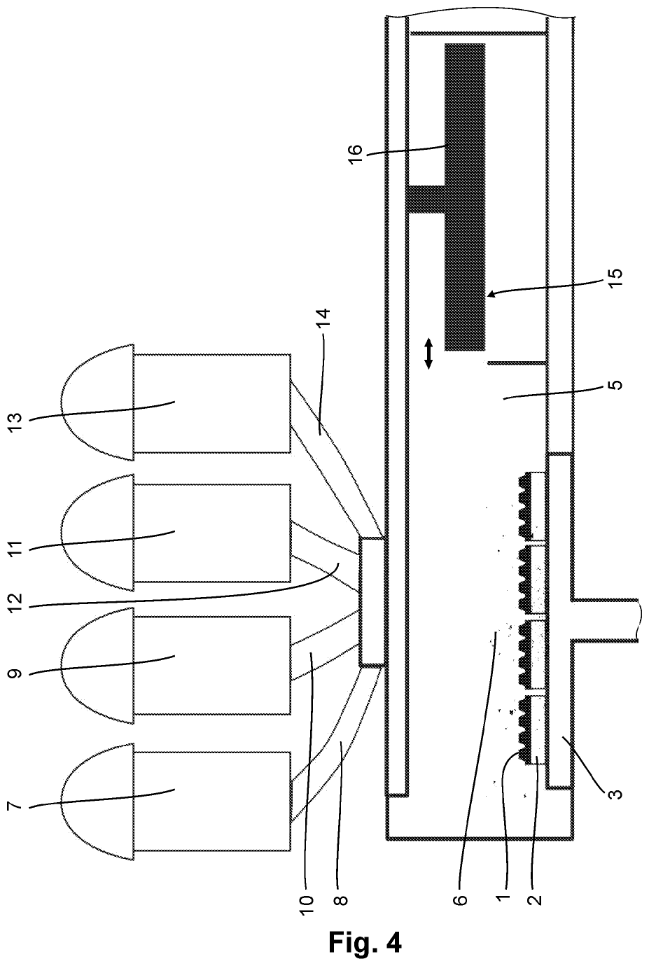

FIG. 3 shows the suction of the fiber material-air mixture 6 through the porous wall 4 of the suction mold 2 and the compaction of the fiber material and the additives to form the molded fiber product 1 at the wall 4. For this purpose, first the second opening in the top wall of the chamber 5 is closed. The air of the fiber material-air mixture 6 is then sucked through the pores in the porous wall 4, as described above. This way, the moistened fiber material, the moistened sugar and the wax are deposited on the porous wall 4 because the pores are smaller than the fibers, the sugar particles and the wax particles. The fiber material, sugar and wax are deposited and compacted on the porous wall 4. During the deposition of the fiber material, sugar and wax, the porous wall 4 of the suction mold 2 is heated to a temperature in the range of 180° C. to 240° C., for example 200° C., using a second heating device. This causes the water from the moistened starting materials to evaporate very quickly and the molded fiber product dries. Some of the evaporated water is sucked through the suction mold 2 and some is fed back into the fiber material-air mixture 6. At the same time, the sugar particles and wax particles deposited on the suction mold 2 fuse, so that these additives are deposited in liquid form around the fibers. The molded fiber product 1 shown in FIG. 3 is not yet finished. After a certain suction time, the finished deposited molded fiber product 1 shown in FIG. 4 is formed in the manner described herein with evenly distributed starting materials and a desired wall thickness.

Optionally, the suction process may take place during a first suction time with a first fiber material-air mixture 6 and during a subsequent second suction time with a second fiber material-air mixture 6. The second mixture may have a different composition than the first mixture. In this way, two layers with different properties, for example color, impermeability, water resistance or the like, are formed on the suction mold 2.

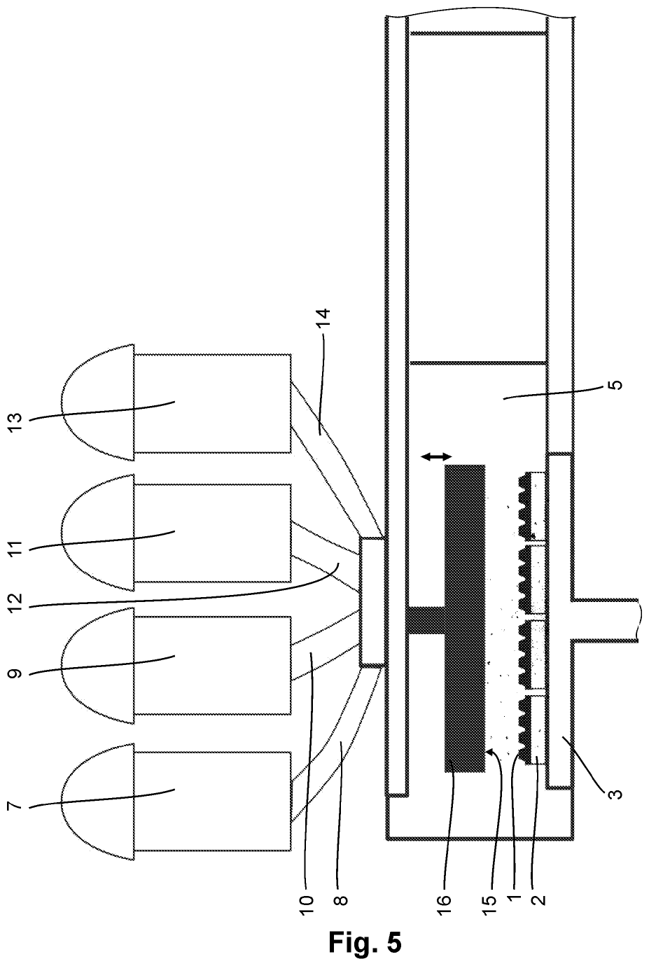

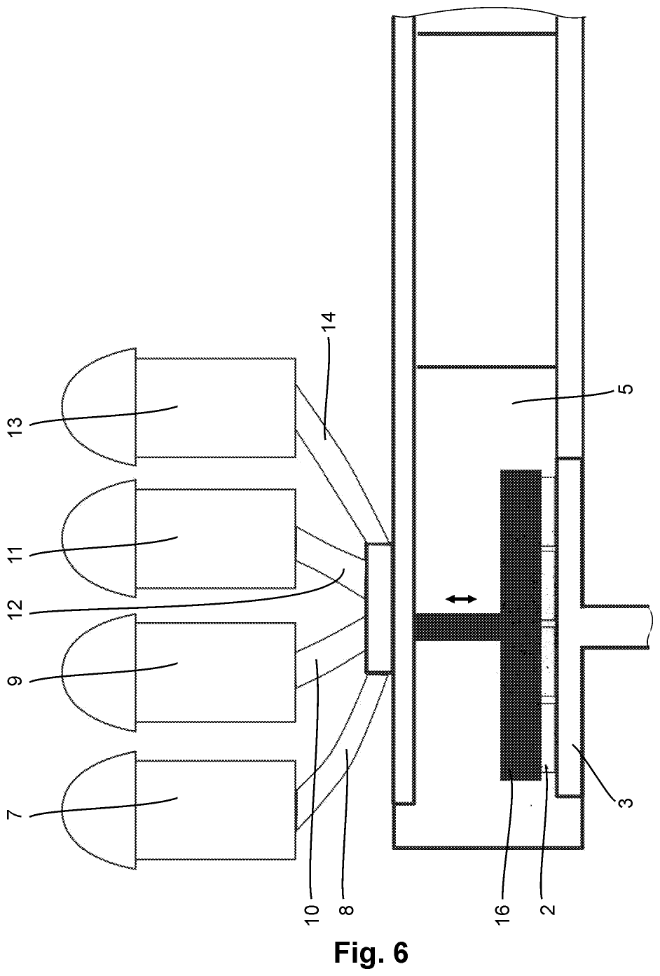

After the molded fiber product 1 is formed on the porous wall 4, the molded fiber product 1 is removed from the suction mold 2. FIG. 4 to FIG. 7 show that first a third opening in a side wall of the chamber 5 is opened for this purpose (FIG. 4). A transfer mold 15, which is arranged on a transfer mold carrier 16, is introduced into the chamber 5 through the third opening and placed above the suction mold 2 and the molded fiber product 1 (FIG. 5). The transfer mold carrier 16 is lowered and the transfer mold 15 is brought into engagement with the suction mold 2 in such a way that a porous wall (not shown) of the transfer mold 15 lies flat against the molded fiber product 1 (FIG. 6). The molded fiber product 1 thus lies between the porous wall 4 of the suction mold 2 and the porous wall of the transfer mold 15. The transfer mold 15 may be pressed against the suction mold 2 with an axial pressure, so that the molded fiber product 1 located in between is already compacted before removal. This applies in particular if the porous wall of the suction mold 2 is stable, e.g., if the porous wall was made of plastic or a metal by additive manufacturing.

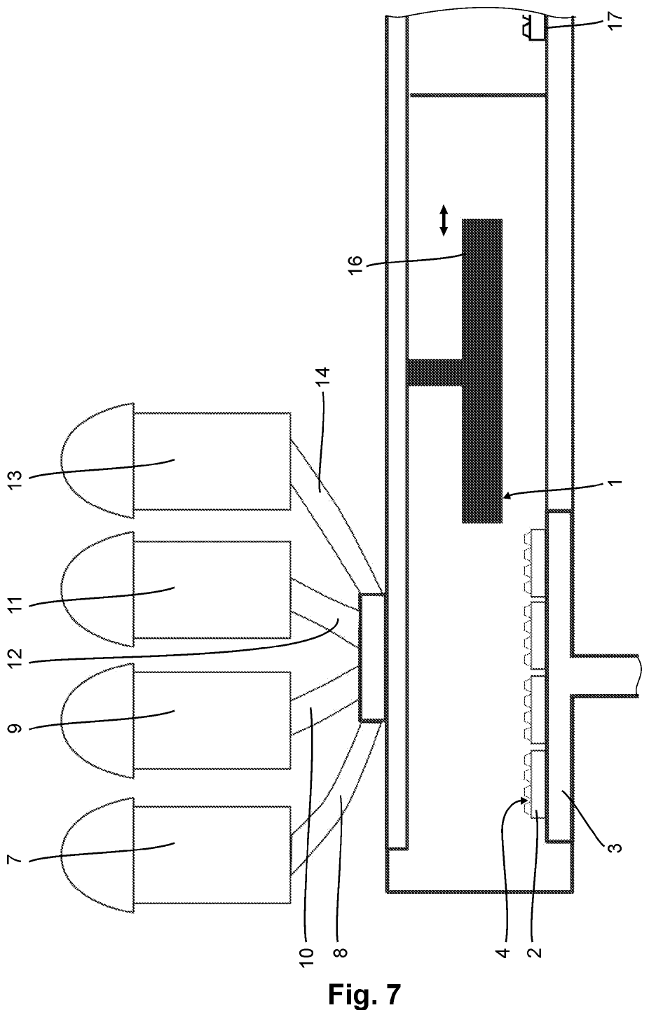

For removal, the molded fiber product 1 is sucked through the pores in the porous wall of the transfer mold 15, while air is blown through the pores in the porous wall 4 of the suction mold 2. The molded fiber product 1 may thus be easily lifted by the transfer mold 15. The molded fiber product 1 is then removed from the chamber 5 through the third opening using the transfer mold 15 (FIG. 7). The third opening is closed again, so that the method described above for forming a molded fiber product on the suction mold 2 arranged in the chamber 5 may be repeated.

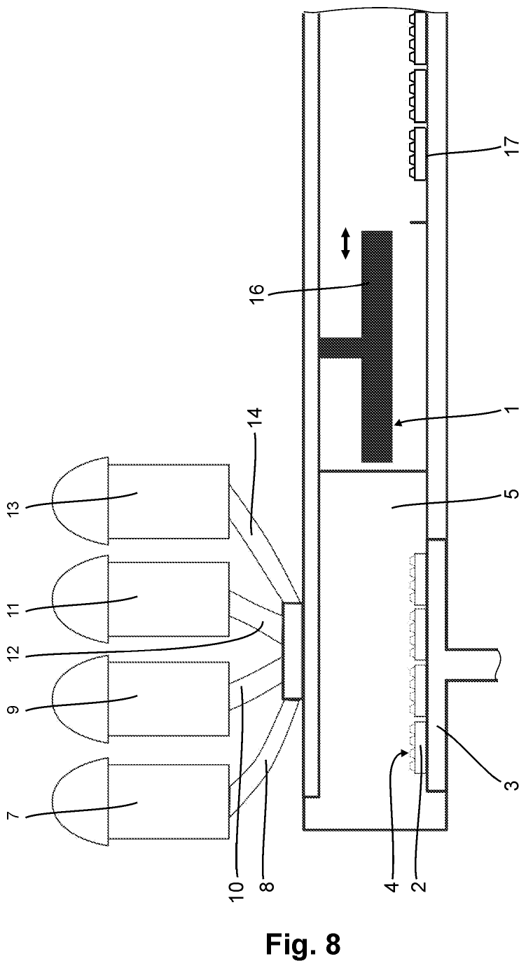

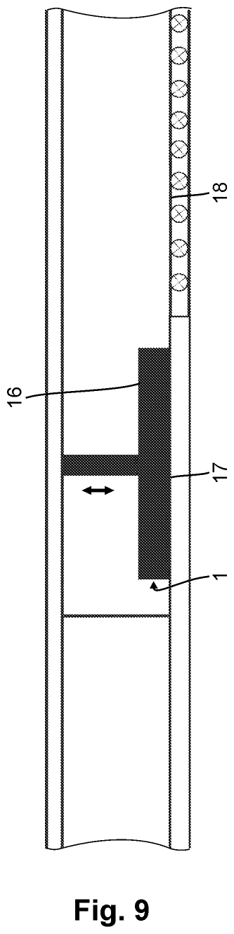

The molded fiber product 1 removed from the chamber 5 and held by the transfer mold 15 is transferred to a press mold 17, as shown in FIG. 8 and FIG. 9. The molded fiber product 1 is pressed in the press mold 17. For pressing, the transfer mold 15 with the molded fiber product 1 arranged thereon is pressed against a porous wall (not shown) of the press mold 17, which is substantially complementary to the porous wall of the transfer mold 15. During pressing, the transfer mold 15 is thus also functionally a counter mold for the press mold 17. The porous walls of the transfer mold 15 and the press mold 17 taken together contain significantly fewer pores than the porous wall 4 of the suction mold 2. As a result, the surfaces of the porous walls of the transfer mold 15 and the press mold 17 are smoother than the surface of the porous wall 4 of the suction mold. Pressing compacts the molded fiber product 1, where moisture is pressed out and the fibers are pressed closely together, so that the strength and impermeability of the molded fiber product 1 increase. Furthermore, the desired final geometry is imprinted on the molded fiber product 1, e.g., by increasing the sharpness of any existing edges, and the surface of the molded fiber product 1 is smoothed.

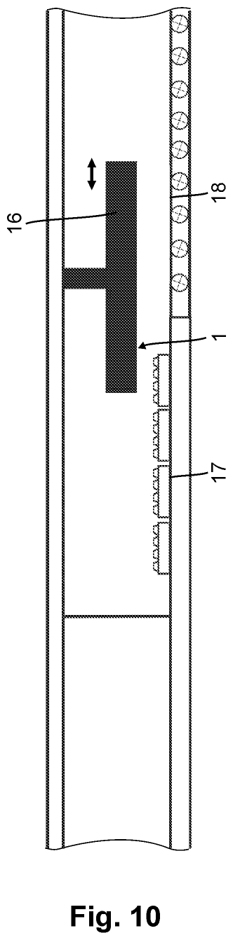

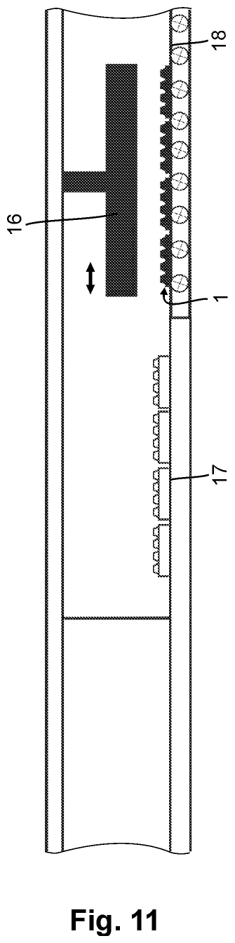

After the molded fiber product 1 is pressed, the molded fiber product 1 is transferred to a conveyor 18 by the transfer mold 15, as shown in FIG. 10. When the transfer mold 17 is arranged above the conveyor 18, the suction of the molded fiber product 1 is terminated and air is blown off through the porous wall of the transfer mold 17, so that the molded fiber product 1 is deposited on the conveyor 18, as shown in FIG. 11. The conveyor 18 transports the molded fiber product 1 to a coating station, not shown here, in which the molded fiber product 1 is sprayed with a coating solution containing cellulose fibers, casein, whey, agar and/or psyllium husks. Alternatively, the conveyor 18 may transport the molded fiber product 1 to an intermediate storage area.

The elements of the device described above are functionally connected to a control unit that monitors and controls the parameters of the process. In particular, the control unit controls
opening or closing the first, second and third openings,
the suction mold carrier,
the feed of the starting materials into the chamber (e.g. point in time and quantity),
the devices for heating the water and the suction mold,
the device for mixing the fiber material with air (e.g. point in time and intensity),
the suction of fiber material-air mixture through the suction mold (e.g. point in time and intensity),
the transfer mold carrier (e.g. the movement and suction of the molded fiber product),
the pressure in the press mold, and
the movement of the conveyor.

By controlling these elements of the device, the method may be carried out automatically.

The features of the invention disclosed in the present description, in the drawings and in the claims may be essential, both individually and in any combination, for the realization of the invention in its various embodiments. The invention is not limited to the described embodiments. It may be varied within the scope of the claims and taking into account the knowledge of the relevant person skilled in the art.

1. A method for producing a molded fiber product, comprising:
arranging in a chamber a suction mold with a porous wall having a contour corresponding to the contour of the molded fiber product to be produced;
introducing a fiber material-air mixture into the chamber, the fiber material being distributed in the air in the form of solid particles;
sucking the fiber material-air mixture through the porous wall of the suction mold and compacting the fiber material to form the molded fiber product on the porous wall;
removing the molded fiber product from the suction mold and from the chamber, wherein the fiber material consists mainly of cellulose fibers, the fiber material being moist and/or water in the form of droplets or water vapor being added to the fiber material-air mixture.

2. The method according to claim 1, wherein
a first fiber material-air mixture is introduced into the chamber and sucked in, so that a first layer of fiber material is formed on the porous wall of the suction mold;
at least one further fiber material-air mixture is introduced into the chamber and sucked in, so that at least one further layer of fiber material is formed on the porous wall of the suction mold; and
the layers of the fiber material are compacted to form the molded fiber product on the porous wall and the molded fiber product is removed from the suction mold.

3. The method according to claim 1, wherein the porous wall of the suction mold has a three-dimensional contour with several wall sections.

4. The method according to claim 1, wherein the fiber material in the form of fiber dust is mixed with the air to form the fiber material-air mixture and/or the fiber material-air mixture is an aerosol, the fiber material being distributed in the air as solid suspended particles.

5. The method according to one of claim 1, wherein at least one of the following additives is added to the fiber material/air mixture:
sugar and/or starch,
wax,
lipids,
minerals.

6. The method according to claim 5, wherein the additives are stored in separate storage containers.

7. The method according to claim 1, wherein, after removal from the suction mold, a molded fiber body is transferred into a press mold and a counter mold is pressed against the molded fiber body arranged in the press mold.

8. The method according to claim 7, wherein removal and/or transfer of the molded fiber body from the suction mold to the press mold is carried out using a transfer mold.

9. The method according to claim 1, wherein the suction mold, the press mold and/or the counter mold are heated.

10. The method according to claim 1, wherein the molded fiber body is additionally coated with a coating solution.

11. A device for producing a molded fiber product, comprising:
a chamber;
at least one device for mixing fiber material with air to produce a fiber material-air mixture in the chamber;
at least one feeding device for water in the form of droplets and/or water vapor;
at least one suction mold which may be introduced into the chamber and has a porous wall to deposit and compact fiber material from the fiber material-air mixture, the contour of the porous wall corresponding to the contour of the molded fiber product to be produced, and
at least one suction device.

12. The device according to claim 11, wherein the device for mixing the fiber material with air includes a propeller and/or an oscillating membrane.

13. The device according to claim 11, wherein the device includes at least one of the following features:
at least one suction mold carrier that may be driven by means of an actuator;
separate storage containers for the fiber material, water, sugar, wax and/or lipids;
at least one device for heating the fiber material, water, sugar and/or wax;
at least one device for mixing water, sugar and/or wax with air;
at least one transfer mold;
at least one transfer mold carrier which may be driven by an actuator;
at least one press mold and at least one counter mold for pressing the molded fiber product;
at least one device for heating the suction mold, the press mold and/or the counter mold;
at least one coating station for coating the molded fiber product; and/or
at least one control unit.
